(19) United States
(12) Patent Application Publication
(10) Pub. No.: US 2024/0178552 A1
(43) Pub. Date: May 30, 2024

(54) TRANSPARENT NFC ANTENNA

(71) Applicant: Meta Platforms Technologies, LLC, Menlo Park, CA (US)

(72) Inventors: Wei Huang, San Diego, CA (US); Yasuo Morimoto, Cupertino, CA (US); Boon Shiu, Palo Alto, CA (US); Jiang Zhu, Cupertino, CA (US); Yonghua Wei, San Diego, CA (US); Geng Ye, Union City, CA (US)

(21) Appl. No.: 18/505,379

(22) Filed: Nov. 9, 2023

Related U.S. Application Data
(60) Provisional application No. 63/385,582, filed on Nov. 30, 2022.

(51) Int. Cl. H01Q 1/27; G04G 17/04; G04G 21/04; H01Q 1/36

(52) U.S. Cl. CPC H01Q 1/273; G04G 17/04; G04G 21/04; H01Q 1/36; G04G 21/025

(57) ABSTRACT

The disclosed apparatus may include a transparent NFC antenna that includes a transparent portion and a non-transparent portion. The transparent NFC antenna improves the radiation efficiency of standard NFC antennas by including a transparent conducting film such as metal mesh in the transparent portion, and metalized film in the non-transparent portion. The metalized film can extend along a narrow width of the perimeter of the transparent portion. In one implementation, the transparent NFC antenna can be incorporated into a touch-enabled display panel of a wrist-wearable device without interfering with the usability or viewability of the touch-enabled display panel. Various other implementations are also disclosed.

### CROSS REFERENCE TO RELATED APPLICATION

This application claims the benefit of U.S. Provisional Application No. 63/385,582, filed Nov. 30, 2022, the disclosure of which is incorporated, in its entirety, by this reference.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1A illustrates a schematic view of a wireless antenna including a partially transparent coil structure in accordance with one or more implementations.

FIG. 1B illustrates a side-view of the wireless antenna of FIG. 1A in accordance with one or more implementations.

FIG. 1C illustrates a perspective view of the wireless antenna of FIG. 1A within a metal housing in accordance with one or more implementations.

FIG. 2A illustrates a schematic view of a wireless antenna including a partially transparent coil structure and a standard NFC coil in accordance with one or more implementations.

FIG. 2B illustrates a results graph showing a coupling force created between the partially transparent coil structure and the standard NFC coil in accordance with one or more implementations.

FIG. 3A illustrates a wireless antenna including a transparent coil in a single turn versus a wireless antenna including two turns of transparent coil in accordance with one or more implementations.

FIG. 3B illustrates the coupling force created by the increased inductance of the wireless antenna including two turns of transparent coil in accordance with one or more implementations.

FIGS. 4A and 4B are illustrations of an exemplary human-machine interface configured to work around a user's lower arm or wrist.

FIGS. 5A and 5B are illustrations of an exemplary schematic diagram with internal components of a wearable system.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION OF EXEMPLARY IMPLEMENTATIONS

Near-field communication (NFC) enabled technologies (such as contactless payment features or pairing and sharing features between devices) have become an increasingly important feature in personal computing devices such as smartphones and smartwatch products. In addition, the increasing popularity of virtual reality (VR), augmented reality (AR), and related devices, many of which connect to and interface with personal computing devices, has placed an increased demand on the volume of wireless data, and the resulting wireless connectivity features (such as cellular, GPS, WIFI, BLUETOOTH, etc.), that must be supported by such devices. Moreover, these wireless features, and their corresponding connectivity antennas, all must fit within the compact, lightweight form factor of personal computing devices, such as a wrist-worn watch body.

Transparent conducting films such as transparent metal mesh, indium tin oxide (ITO), or a combination of the same can offer up to 98% optical transmission with relatively high conductivity. As such, transparent conducting films can serve as an alternative to conventional wireless antennas (e.g., flex-based, printed circuit board-type NFC coil antennas) integrated within display touch panels and can greatly reduce the amount of physical space occupied by the same. However, while transparent conductors have relatively high conductivity, they are often unable to conduct as well as conventional metals, such as copper or silver, etc. Accordingly, a coil structure made of transparent conductors will suffer greater Ohmic loss and have less radiation efficiency than a coil structure made of conventional metals. What is needed, therefore, is a design that incorporates the benefits of transparent conductors in an optically transparent antenna while maintaining antenna radiation efficiency.

Thus, the present disclosure describes an NFC antenna without a ferrite substrate that is designed for wrist wearable devices and integrated into a display touch panel. For example, as will be described in greater detail below, implementations of the disclosed NFC antenna include both transparent and non-transparent conducting portions. In one or more implementations, the transparent conducting portions can include a transparent film of metal mesh. Due to the transparency of these conducting portions, these portions may be positioned over or adjacent to a display and/or touch panel of a smart watch. The non-transparent conducting portions can include a metalized film and can be positioned along a perimeter of the display and/or touch panel such that it does not interfere with the viewable/usable area of the display or touch panel.

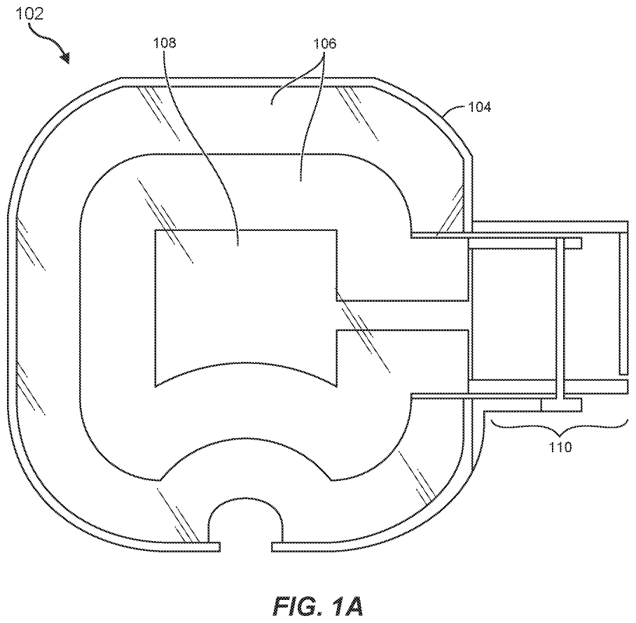

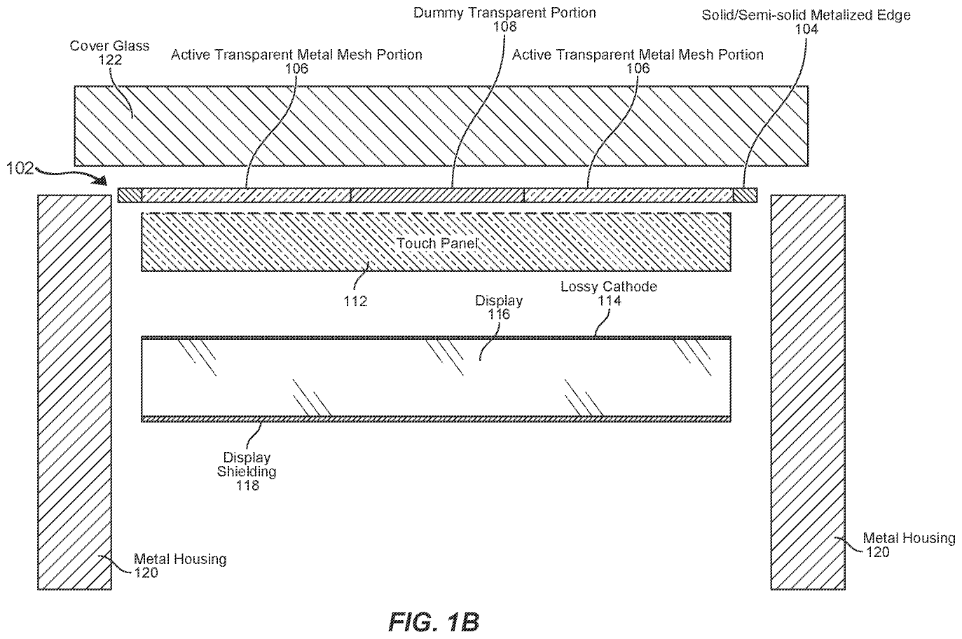

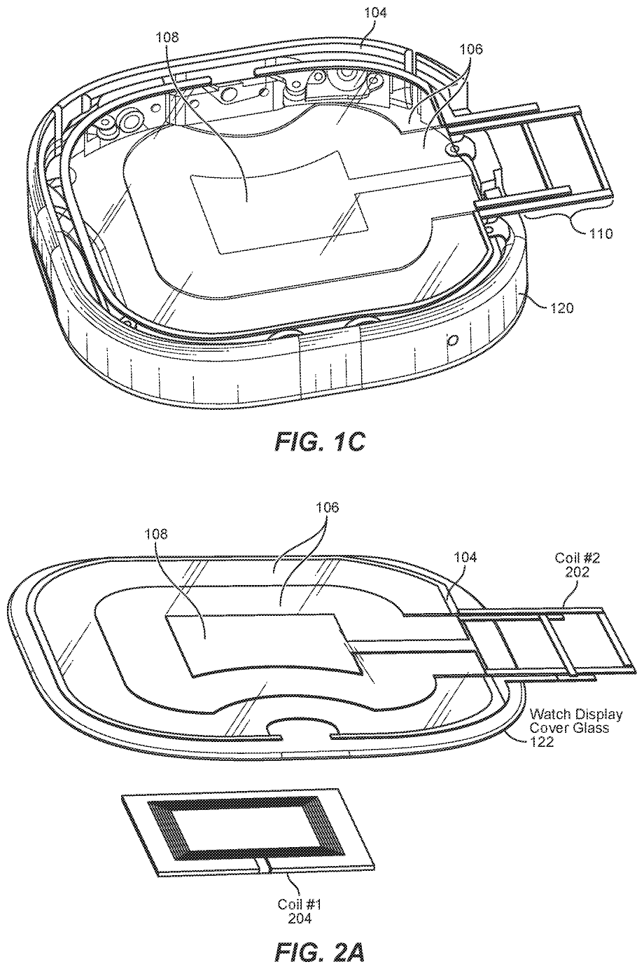

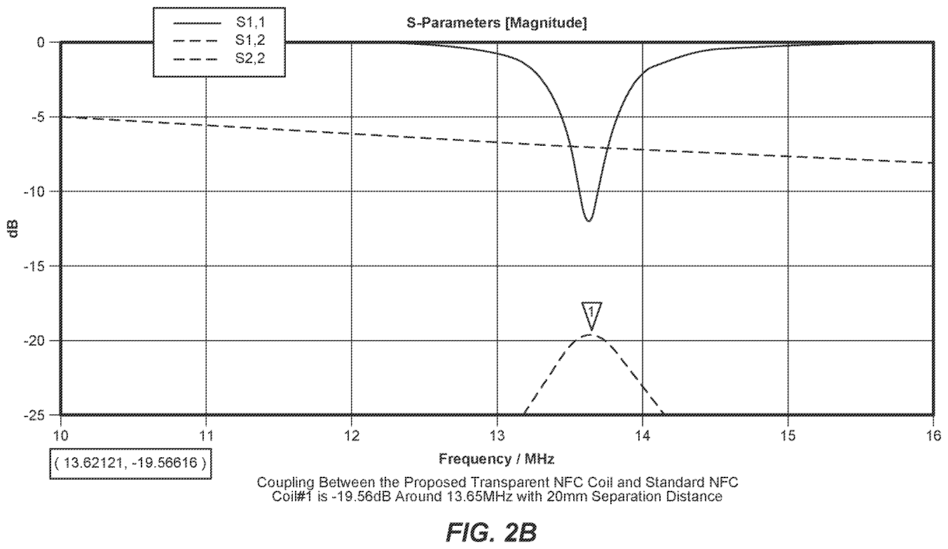

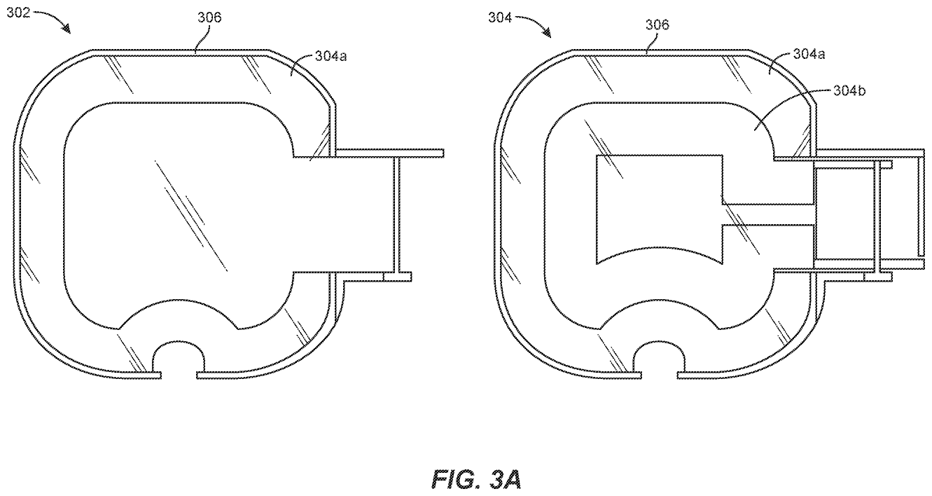

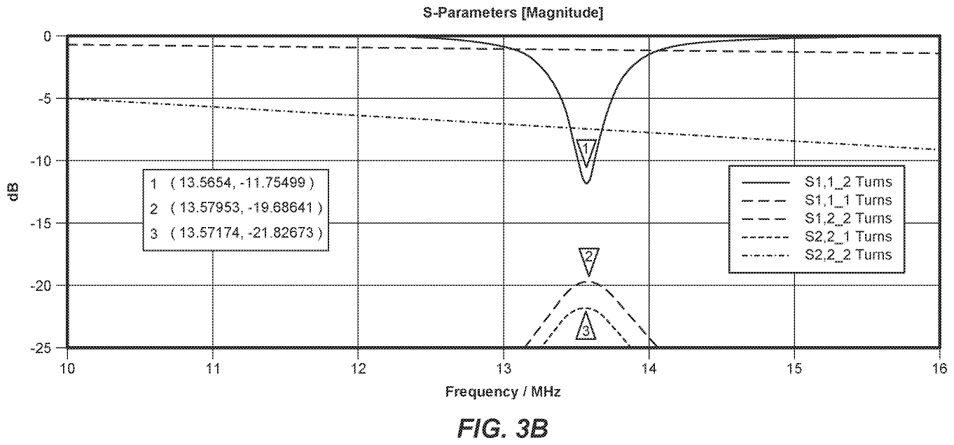

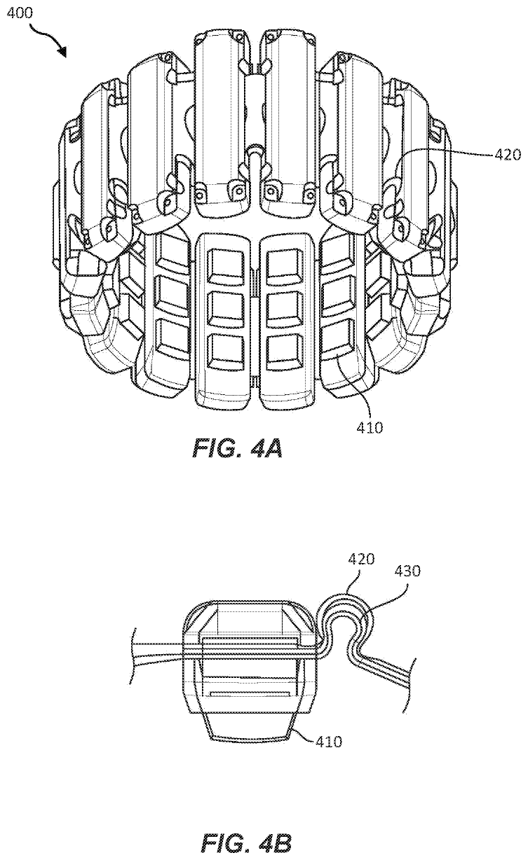

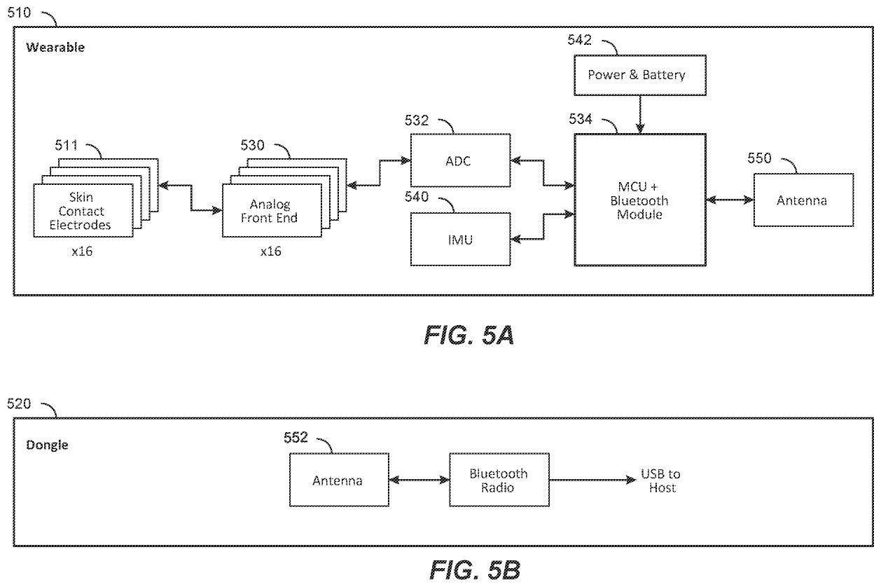

The following will provide, with reference to the FIGS. 1A-5B, detailed descriptions of a transparent NFC antenna. For example, FIGS. 1A-1C illustrate an example wireless antenna including both transparent conducting film and a metalized edge film. FIGS. 2A and 2B illustrate another implementation of the wireless antenna including a transparent NFC antenna and a standard NFC antenna. FIGS. 3A and 3B illustrate the transparent NFC antenna including multiple turns of transparent coil. FIGS. 4A and 4B illustrate an exemplary human-machine interface configured to work around a user's lower arm or wrist, while FIGS. 5A and 5B include an exemplary schematic diagram with internal components of a wearable system.

In more detail, FIG. 1A shows a schematic diagram of a wireless, transparent NFC antenna 102. In one or more implementations, the transparent NFC antenna 102 includes a coil structure that includes a transparent portion 106 and a non-transparent portion 104. For example, the transparent portion 106 can include a transparent antenna radiator made of transparent conducting film. This transparent conducting film in the transparent portion 106 can include active metal mesh, indium tin oxide (ITO), or other material that provides optical transparency and conductivity at radio frequencies (e.g., 20 kHz-300 GHz).

In one or more implementations, the non-transparent portion 104 can include a metalized film edge that extends along all or a portion of the transparent portion 106. For example, the metalized film edge of the non-transparent portion 104 can be located at an outermost portion of the coil structure of the transparent NFC antenna 102. In at least one implementation, the metalized film edge of the non-transparent portion 104 has higher conductivity than the metal mesh of the transparent portion 106. As further shown in FIG. 1A, the transparent NFC antenna 102 can further include additional connections 110 that serve to connect the non-transparent portion 104 and the transparent portion 106 to one or more additional integrated circuits and/or control systems.

As further shown in FIG. 1A, the transparent portion 106 can further include a dummy transparent metal mesh portion 108. In one or more implementations, the inactive transparent metal mesh portion 108 serves as fill that does not transmit or receive data. In some implementations, this is due to breaks in the metal mesh of the inactive transparent metal mesh portion 108. Conversely, the active transparent mesh in the transparent portion 106 can include unbroken metal mesh and can therefore transmit and receive data. In at least one implementation, the active metal mesh of the transparent portion 106 can have an electrical connection to the non-transparent portion 104 within the transparent NFC antenna 102

As mentioned above, the transparent NFC antenna 102 can be integrated into a wrist-wearable device such as a smart watch with a touch screen display. FIG. 1B illustrates a side-view of the transparent NFC antenna 102 configured as part of a wrist-wearable device. For example, as shown in FIG. 1B, the coil structure of the transparent NFC antenna 102 can include the dummy transparent mesh portion 108 surrounded by the transparent portion 106 including active transparent metal mesh. The coil structure can further include the transparent portion 106 surrounded by the non-transparent portion 104 including a solid/semi-solid metalized edge.

In one or more implementations, the transparent NFC antenna 102 may be integrated with a touch panel 112. For example, the touch panel 112 can include an active touch area that detects and registers user interactions where the user's fingers come in contact with a cover glass 122 of the wrist-wearable device. The touch panel 112 may be further positioned over a display 116 including a lossy cathode 114 and display shielding 118. Thus, the display 116 and the touch panel 112 may make up a display panel that is touch-enabled. In at least one implementation, the display 116 is viewable through both the touch panel 112 and the transparent portion 106/dummy transparent mesh portion 108 of the coil structure within the transparent NFC antenna 102.

As further shown in FIG. 1B, the cover glass 122 may be positioned over the stack including the transparent NFC antenna 102, the touch panel 112, and the display 116. In one or more implementations, the cover glass 122 may include a black masking area along its perimeter that effectively hides the non-transparent portion 104 of the transparent NFC antenna 102. As such, in this configuration, the non-transparent portion 104 may not be viewable by a user looking through the cover glass 122. For example, the non-transparent portion 104 can include a width that is completely obscured by the black masking area on the cover glass 122. In one or more implementations, the transparent NFC antenna 102 transmits and receives data at a wavelength A. In at least one implementation, the non-transparent portion 104 can include a narrow width of no more than λ/20 (e.g., one-twentieth the transmission wavelength). As such, the black masking area on the cover glass 122 may be very narrow while still keeping the non-transparent portion 104 from being viewed by the user. Similarly, the narrow width of the non-transparent portion 104 further serves to maximize the usable area of the touch panel 112 and the viewable area of the display 116 positioned beneath the transparent NFC antenna 102.

Additionally, as shown in FIG. 1B, the stack including the transparent NFC antenna 102, the touch panel 112, and the display 116 may be enclosed in a metal housing 120. In one or more implementations, as illustrated by FIG. 1C, the metal housing 120 may be part of the body of the wrist-wearable device. As such, the metal housing 120 may include other components such as integrated circuits, CPUs, digital storage, etc. In this implementation, the additional connections 110 of the non-transparent portion 104 and the transparent portion 106 may extend beyond the metal housing 120.

In at least one implementation, the transparent NFC antenna 102 may be used in connection with conventional NFC antennas. For Example, as shown in FIG. 2A, a device may include a first coil structure 204 including a standard NFC antenna and a second coil structure 202 including the transparent NFC antenna 102. As discussed above, the second coil structure 202 may include the non-transparent portion 104, the transparent portion 106, and the dummy transparent mesh portion 108.

As further illustrated in FIG. 2B, the distance between the first coil structure 204 and the second coil structure 202 can affect coupling between both coil structures. For example, as shown in FIG. 2B, when the first coil structure 204 is positioned at a twenty millimeter separation distance from the second coil structure 202, the coupling between the first coil structure 204 and the second coil structure 202 is approximately −19.56 decibels (dB) at around 13.65 megahertz (MHz). In at least one implementation, the minimum distance between the second coil structure 202 and the first coil structure 204 for an H-field of at least 1.5 amps per meter(A/m) range is 30 millimeters. Moreover, when positioned within a metal enclosure such as the metal housing 120, the coupling between the first coil structure 204 and the second coil structure 202 may degrade by about 0.1 dB.

In one or more implementations, the number of transparent coil turns within a transparent NFC antenna can affect the inductance of the transparent NFC antenna. For example, as shown in FIG. 3A, a first transparent NFC antenna 302 may include a non-transparent radiator 306 including a non-transparent metalized edge (e.g., similar to the non-transparent portion 104 discussed above). Additionally, the first transparent NFC antenna 302 may also include a first turn 304a of coil including a transparent metal mesh radiator. This configuration, however, may not provide enough inductance for the first transparent NFC antenna 302.

As such, and as further shown in FIG. 3A, a second transparent NFC antenna 304 may include the non-transparent radiator 306, the first turn 304a of transparent coil, and a second turn 304b of transparent coil. In at least one implementation, the second turn 304b includes the same transparent metal mesh as the first turn 304a. As demonstrated by the chart in FIG. 3B, the second turn 304b can increase the inductance of the second transparent NFC antenna 304 such that the second transparent NFC antenna 304 may be appropriately coupled with a second, conventional NFC antenna (e.g., as discussed above with reference to FIG. 2A.

As such, the transparent NFC antenna discussed herein can enable near-field communication for compact wireless devices. Such compact wireless devices can include wireless wrist-wearable devices or other mobile devices that include a touch-enabled display panel. As discussed above, the transparent NFC antenna can include transparent conducting film such as transparent metal mesh that can be included as part of the touch-enabled display panel without interfering with the usability and/or viewability of that panel. Moreover, the transparent NFC antenna increases the efficiency of the transparent metal mesh by including a non-transparent metalized film edge that extends along an outermost perimeter of the touch-enable display panel. In at least one implementation, the non-transparent metalized film edge is covered with black tape so as to be hidden from the user. Thus, the transparent NFC antenna presents multiple improvements over standard NFC antennas without the need for ferrite substrate or other similar materials.

### EXAMPLE IMPLEMENTATIONS

Example 1: A wireless antenna including a coil structure that includes a transparent portion, and a non-transparent portion, wherein the coil structure is integrated within a display panel.

Example 2: The wireless antenna of Example 1, wherein the transparent portion is formed of a transparent conducting film.

Example 3: The wireless antenna of Examples 1 and 2, wherein the transparent conducting film comprises at least one of a metal mesh or indium tin oxide.

Example 4: The wireless antenna of any of Examples 1-3, wherein the metal mesh comprises an active metal mesh and an inactive metal mesh.

Example 5: The wireless antenna of any of Examples 1-4, wherein the active metal mesh is electrically connected to the non-transparent portion, and both the active metal mesh of the transparent portion and the non-transparent portion form part of the wireless antenna.

Example 6: The wireless antenna of any of Examples 1-5, wherein the wireless antenna does not include a ferrite substrate.

Example 7: The wireless antenna of any of Examples 1-6, wherein the non-transparent portion is located at an outermost portion of the coil structure around a perimeter of the display panel.

Example 8: The wireless antenna of any of Examples 1-7, wherein the non-transparent portion has a higher conductivity than the transparent portion.

Example 9: The wireless antenna of any of Examples 1-8, wherein the transparent portion is positioned under the display panel and the non-transparent portion is positioned and hidden under a black masking area.

Example 10: The wireless antenna of any of Examples 1-9, wherein the non-transparent portion extends along all or some of a perimeter of the display panel.

Example 11: The wireless antenna of any of Examples 1-10, wherein the non-transparent portion has a width of less than approximately λ/20.

Example 12: The wireless antenna of any of Examples 1-11, wherein the wireless antenna is a near-field communication (NFC) antenna.

Example 13: The wireless antenna of any of Examples 1-12, wherein the display panel is a touch-enabled display panel.

Example 14: A wireless antenna including a first coil structure including a standard NFC coil, and a second coil structure including a transparent portion and a non-transparent portion, wherein the second coil structure is positioned above the first coil structure within a display panel.

Example 15: The wireless antenna of Example 14, wherein the second coil structure is positioned above the first coil structure at a distance of 20 millimeters.

Example 16: The wireless antenna of Examples 14 and 15, wherein positioning the second coil structure above the first coil structure creates a coupling force.

Example 17: The wireless antenna of any of Examples 14-16, wherein the coupling force between the first coil structure and the second coil structure comprises −19.56 dB at 13.65 MHz with 20 millimeters of separation distance.

Example 18: The method of any of Examples 11-17, wherein the display panel is held in place by a metal enclosure.

Example 19: The wireless antenna of any of Examples 14-18, wherein the metal enclosure is part of a wrist-wearable device.

Example 20: A wireless antenna including a coil structure that includes a non-transparent metalized edge that extends along a perimeter of a display panel, a first transparent conductor portion that extends along an inner perimeter of the non-transparent metalized edge, and a second transparent conductor portion that extends along an inner perimeter of the first transparent conductor portion.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

In some examples, the examples described herein may be incorporated within a wrist-worn human-machine interface. FIG. 4A illustrates an exemplary human-machine interface (also referred to herein as an EMG control interface) configured to be worn around a user's lower arm or wrist as a wearable system 400. In this example, wearable system 400 may include sixteen neuromuscular sensors 410 (e.g., EMG sensors) arranged circumferentially around an elastic band 420 with an interior surface 430 configured to contact a user's skin. However, any suitable number of neuromuscular sensors may be used. The number and arrangement of neuromuscular sensors may depend on the particular application for which the wearable device is used. For example, a wearable armband or wristband can be used to generate control information for controlling an augmented reality system, a robot, controlling a vehicle, scrolling through text, controlling a virtual avatar, or any other suitable control task. As shown, the sensors may be coupled together using flexible electronics incorporated into the wireless device. FIG. 4B illustrates a cross-sectional view through one of the sensors of the wearable device shown in FIG. 4A. In some embodiments, the output of one or more of the sensing components can be optionally processed using hardware signal processing circuitry (e.g., to perform amplification, filtering, and/or rectification). In other embodiments, at least some signal processing of the output of the sensing components can be performed in software. Thus, signal processing of signals sampled by the sensors can be performed in hardware, software, or by any suitable combination of hardware and software, as aspects of the technology described herein are not limited in this respect. A non-limiting example of a signal processing chain used to process recorded data from sensors 410 is discussed in more detail below with reference to FIGS. 5A and 5B.

FIGS. 5A and 5B illustrate an exemplary schematic diagram with internal components of a wearable system with EMG sensors. As shown, the wearable system may include a wearable portion 510 (FIG. 5A) and a dongle portion 520 (FIG. 5B) in communication with the wearable portion 510 (e.g., via BLUETOOTH or another suitable wireless communication technology). As shown in FIG. 5A, the wearable portion 510 may include skin contact electrodes 511, examples of which are described in connection with FIGS. 4A and 4B. The output of the skin contact electrodes 511 may be provided to analog front end 530, which may be configured to perform analog processing (e.g., amplification, noise reduction, filtering, etc.) on the recorded signals. The processed analog signals may then be provided to analog-to-digital converter 532, which may convert the analog signals to digital signals that can be processed by one or more computer processors. An example of a computer processor that may be used in accordance with some embodiments is microcontroller (MCU) 534, illustrated in FIG. 5A. As shown, MCU 534 may also include inputs from other sensors (e.g., IMU sensor 540), and power and battery module 542. The output of the processing performed by MCU 534 may be provided to antenna 550 for transmission to dongle portion 520 shown in FIG. 5B.

Dongle portion 520 may include antenna 552, which may be configured to communicate with antenna 550 included as part of wearable portion 510. Communication between antennas 550 and 552 may occur using any suitable wireless technology and protocol, non-limiting examples of which include radiofrequency signaling and BLUETOOTH. As shown, the signals received by antenna 552 of dongle portion 520 may be provided to a host computer for further processing, display, and/or for effecting control of a particular physical or virtual object or objects.

Although the examples provided with reference to FIGS. 4A-4B and FIGS. 5A-5B are discussed in the context of interfaces with EMG sensors, the techniques described herein for reducing electromagnetic interference can also be implemented in wearable interfaces with other types of sensors including, but not limited to, mechanomyography (MMG) sensors, sonomyography (SMG) sensors, and electrical impedance tomography (EIT) sensors. The techniques described herein for reducing electromagnetic interference can also be implemented in wearable interfaces that communicate with computer hosts through wires and cables (e.g., USB cables, optical fiber cables, etc.).

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A wireless antenna comprising:
a coil structure that comprises:
a transparent portion; and
a non-transparent portion;
wherein the coil structure is integrated within a display panel.

2. The wireless antenna of claim 1, wherein the transparent portion is formed of a transparent conducting film.

3. The wireless antenna of claim 2, wherein the transparent conducting film comprises at least one of a metal mesh or indium tin oxide.

4. The wireless antenna of claim 3, wherein the metal mesh comprises an active metal mesh and an inactive metal mesh.

5. The wireless antenna of claim 4, wherein the active metal mesh is electrically connected to the non-transparent portion, and both the active metal mesh of the transparent portion and the non-transparent portion form part of the wireless antenna.

6. The wireless antenna of claim 1, wherein the wireless antenna does not include a ferrite substrate.

7. The wireless antenna of claim 1, wherein the non-transparent portion is located at an outermost portion of the coil structure around a perimeter of the display panel.

8. The wireless antenna of claim 1, wherein the non-transparent portion has a higher conductivity than the transparent portion.

9. The wireless antenna of claim 1, wherein the transparent portion is positioned under the display panel and the non-transparent portion is positioned and hidden under a black masking area.

10. The wireless antenna of claim 1, wherein the non-transparent portion extends along all or some of a perimeter of the display panel.

11. The wireless antenna of claim 1, wherein the non-transparent portion has a width of less than approximately λ/20.

12. The wireless antenna of claim 1, wherein the wireless antenna is a near-field communication (NFC) antenna.

13. The wireless antenna of claim 1, wherein the display panel is a touch-enabled display panel.

14. A wireless antenna comprising:
a first coil structure comprising a standard NFC coil; and
a second coil structure comprising:
a transparent portion; and
a non-transparent portion;
wherein the second coil structure is positioned above the first coil structure within a display panel.

15. The wireless antenna of claim 14, wherein the second coil structure is positioned above the first coil structure at a distance of 20 millimeters.

16. The wireless antenna of claim 15, wherein positioning the second coil structure above the first coil structure creates a coupling force.

17. The wireless antenna of claim 16, wherein the coupling force between the first coil structure and the second coil structure comprises −19.56 decibels at 13.65 megahertz with 20 millimeters of separation distance.

18. The wireless antenna of claim 14, wherein the display panel is held in place by a metal enclosure.

19. The wireless antenna of claim 18, wherein the metal enclosure is part of a wrist-wearable device.

20. A wireless antenna comprising:
a coil structure that comprises:
a non-transparent metalized edge that extends along a perimeter of a display panel;
a first transparent conductor portion that extends along an inner perimeter of the non-transparent metalized edge; and
a second transparent conductor portion that extends along an inner perimeter of the first transparent conductor portion.
